(19) United States
(12) Patent Application Publication
(10) Pub. No.: US 2024/0086636 A1
(43) Pub. Date: Mar. 14, 2024

(54) KEYWORD DETECTION DEVICE, KEYWORD DETECTION METHOD, AND COMPUTER PROGRAM PRODUCT

(71) Applicant: KABUSHIKI KAISHA TOSHIBA, Tokyo (JP)

(72) Inventors: Yuka KOBAYASHI, Seto Aichi (JP); Takami YOSHIDA, Kamakura Kanagawa (JP); Kenji IWATA, Machida Tokyo (JP); Tsuyoshi KUSHIMA, Kawasaki Kanagawa (JP); Hisayoshi NAGAE, Yokohama Kanagawa (JP); Nayuko WATANABE, Kawasaki Kanagawa (JP)

(73) Assignee: KABUSHIKI KAISHA TOSHIBA, Tokyo (JP)

(21) Appl. No.: 18/170,713

(22) Filed: Feb. 17, 2023

(30) Foreign Application Priority Data
Sep. 8, 2022 (JP) 2022-142662

(51) Int. Cl. G06F 40/289; G06F 16/245

(52) U.S. Cl. CPC G06F 40/289; G06F 16/245

(57) ABSTRACT

According to an embodiment, a keyword detection device includes a memory and one or more processors coupled to the memory. The one or more processors are configured to: detect a phrase related to a keyword from text information that is a recognition result of input information represented in a predetermined input form; calculate output similarities conforming to similarities between the phrase and the keywords included in a keyword list in which, for each of a plurality of the keywords, keyword notation of the corresponding keyword is associated with keyword form information representing the corresponding keyword in an input form; and output the keywords in the keyword list according to the output similarities.

### CROSS-REFERENCE TO RELATED APPLICATIONS

This application is based upon and claims the benefit of priority from Japanese Patent Application No. 2022-142662, filed on Sept. 8, 2022; the entire contents of which are incorporated herein by reference.

### FIELD

Embodiments described herein relate generally to a keyword detection device, a keyword detection method, and a computer program product.

### BACKGROUND

Systems are known that recognize input information input by user's utterance or the like and performs processing based on a keyword extracted from the recognition result of the input information. Such systems have the problem of incorrectly detecting a keyword when the recognition result includes an error. Particularly, in many cases, uncommon terms such as technical terms and proper nouns are used as keywords, and misrecognition may be likely to occur.

In the regard, a technique for suppressing misrecognition is disclosed. For example, a technique has been proposed to convert each of a correct keyword and a misrecognized keyword into phonemes, compare a similarity between the phoneme sequences, and consider the phoneme sequence as a correct keyword when the similarity is high. However, such related art is based on the assumption that a keyword alone is uttered, and when input information such as a natural sentence including a keyword is input, specifying the location of the keyword included in the input information has been difficult. A technique is also disclosed to retrieve a phoneme sequence of a correct keyword from a phoneme sequence of a voice recognition result and to specify the location of the keyword. However, in this technique, when an error exists in the phoneme, specifying the location of the keyword has been difficult. That is, in the related art, when the recognition result includes an error, outputting the correct keyword has been difficult.

The problem to be solved by the present invention is to provide a keyword detection device, a keyword detection method, and a computer program product that can output a correct keyword even when the recognition result of input information includes an error.

### BRIEF DESCRIPTION OF THE DRAWINGS

FIG. 1 is a functional block diagram of a keyword detection device;

FIG. 2A is a schematic diagram illustrating the data structure of a keyword list;

FIG. 2B is a schematic diagram illustrating the data structure of a keyword list;

FIG. 3 is a flowchart illustrating the flow of information processing performed by the keyword detection device;

FIG. 4 is a functional block diagram of a keyword detection device;

FIG. 5 is a flowchart illustrating the flow of information processing performed by the keyword detection device;

FIG. 6 is a functional block diagram of a keyword detection device;

FIG. 7 is a flowchart illustrating the flow of information processing performed by the keyword detection device;

FIG. 8 is a functional block diagram of a keyword detection device;

FIG. 9 is a flowchart illustrating the flow of information processing performed by the keyword detection device;

FIG. 10 is a functional block diagram of an example of a keyword detection device;

FIG. 11A is a schematic diagram illustrating the data structure of a keyword list;

FIG. 11B is a schematic diagram illustrating the data structure of a keyword list;

FIG. 12 is a flowchart illustrating the flow of information processing performed by the keyword detection device;

FIG. 13 is a functional block diagram of a keyword detection device;

FIG. 14A is an explanatory diagram of a display screen;

FIG. 14B is an explanatory diagram of a display screen;

FIG. 15 is a flowchart illustrating the flow of information processing performed by the keyword detection device; and

FIG. 16 is a block diagram illustrating a hardware configuration example.

### DETAILED DESCRIPTION

In general, according to one embodiment, a keyword detection device includes a memory and one or more processors coupled to the memory. The one or more processors are configured to: detect a phrase related to a keyword from text information that is a recognition result of input information represented in a predetermined input form; calculate output similarities conforming to similarities between the phrase and keywords included in a keyword list in which, for each of the keywords, keyword notation of the corresponding keyword is associated with keyword form information representing the corresponding keyword in the input form; and output the keywords in the keyword list according to the output similarities.

Exemplary embodiments of a keyword detection device, a keyword detection method, and a computer program product will be explained below in detail with reference to the accompanying drawings. The present invention is not limited to the following embodiments.

### First Embodiment

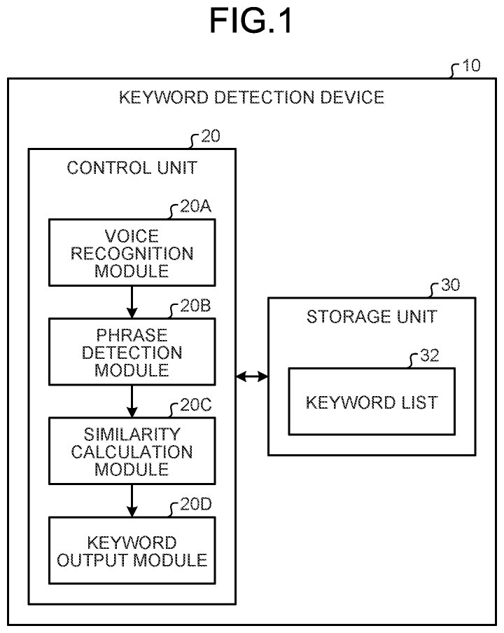

FIG. 1 is a functional block diagram of an example of a keyword detection device 10 of the present embodiment.

The keyword detection device 10 is an information processing device for outputting a correct keyword included in a recognition result from text information that is the recognition result of input information.

The input information is information that is input to the keyword detection device 10. The input information is represented in a predetermined input form. The predetermined input form is an input form of the input information. The input form includes, for example, voice collected by a microphone or the like, key input that is input by an input device such as a keyboard, handwritten character input that is input via a handwriting board or the like, or the like. When the input form is voice, the input information is voice data. When the input form is key input, the input information is a key input signal. When the input form is handwritten character input, the input information is a stroke signal or the like represented by the handwritten character input.

In the present embodiment, an example in which the input form is voice and the input information is voice data will be explained. The present embodiment will be explained on the assumption that the voice is voice uttered by a user. The voice is not limited to the user's utterance.

The keyword detection device 10 includes a control unit 20 and a storage unit 30. The control unit 20 and the storage unit 30 are connected to be able to exchange data and signals.

The storage unit 30 stores various information. In the present embodiment, the storage unit 30 stores a keyword list 32 in advance.

The keyword list 32 is a list in which, for each of a plurality of keywords, keyword notation of the keyword is associated with keyword form information representing the keyword in an input form.

The keyword notation is a character representing a keyword. The keyword form information is information representing a keyword in the input form of input information.

When the input form of the input information is voice, the keyword notation is a character representing a keyword, and the keyword form information is information representing the reading of the keyword. The reading represents the pronunciation of the keyword.

In the present embodiment, an example in which the input form of the input information is voice as described above will be explained. Therefore, in the present embodiment, the keyword notation of a keyword and reading, which is keyword form information, are registered in advance in the keyword list 32 in association with each other. In the following, the keyword notation may be explained by being simply referred to as notation.

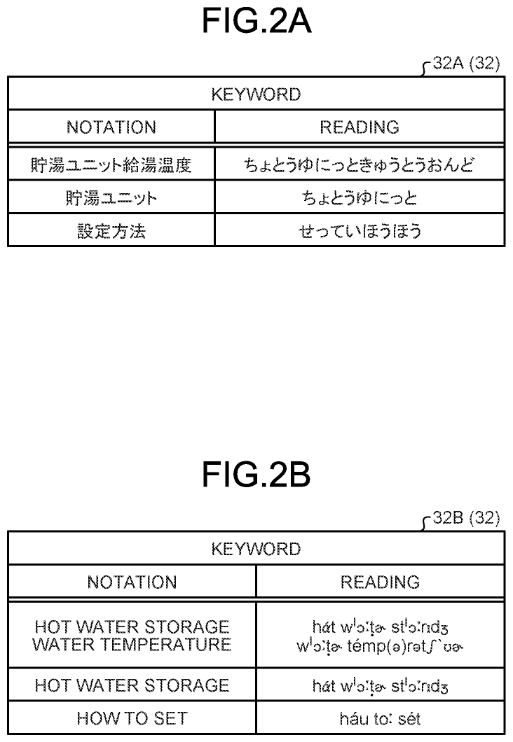

FIG. 2A is a schematic diagram illustrating an example of the data structure of a keyword list 32A. The keyword list 32A is an example of the keyword list 32 when voice, which is input information, is Japanese voice. The keyword list 32A illustrates an example in which notation and reading are registered for each of three keywords in association with each other. Although two or four or more keywords are registered in the keyword list 32A, FIG. 2A illustrates some of the keywords for the sake of simplicity.

FIG. 2B is a schematic diagram illustrating an example of the data structure of a keyword list 32B. The keyword list 32B is an example of the keyword list 32 when voice, which is input information, is English voice. The keyword list 32B illustrates an example in which notation and reading are registered for each of three keywords in association with each other. Herein, reading represents pronunciation, e.g., a phonetic sign. Although two or four or more keywords are registered in the keyword list 32B, FIG. 2B illustrates some of the keywords for the sake of simplicity.

The description is continued by referring now back to FIG. 1. The control unit 20 performs information processing in the keyword detection device 10. The control unit 20 includes a voice recognition module 20A, a phrase detection module 20B, a similarity calculation module 20C, and a keyword output module 20D.

The voice recognition module 20A, the phrase detection module 20B, the similarity calculation module 20C, and the keyword output module 20D are implemented by one or a plurality of processors, for example. For example, each of the above units may be implemented by causing a processor such as a central processing unit (CPU) to execute a computer program, that is, by software. Each of the above units may be implemented by a processor such as a dedicated integrated circuit (IC), that is, hardware. Each of the above units may be implemented using both software and hardware. When a plurality of processors are used, each processor may implement one of the units, or may implement two or more of the units.

The information stored in the storage unit 30 and at least a part of the above units included in the control unit 20 may be configured in an external information processing device communicably connected to the keyword detection device 10.

The voice recognition module 20A acquires voice data as input information, and outputs text information as the recognition result of the voice data. The voice recognition module 20A recognizes the voice data by a known method and outputs the text information as the recognition result. The text information may be represented in either reading or notation, and may be represented by a mixture of reading and notation.

The phrase detection module 20B detects a phrase related to a keyword from the text information that is the recognition result of the input information represented in a predetermined input form.

The phrase represents a part included in the text information, which can be the keyword. In other words, the phrase represents a part that is likely to be the keyword, which is included in the text information. The phrase may be represented in either reading or notation, and may be represented by a mixture of reading and notation.

In the present embodiment, the phrase detection module 20B detects one or a plurality of phrases from the text information that is the recognition result of the voice data.

The text information that is the recognition result may include misrecognition. Therefore, even though the text information is retrieved using a keyword itself, detecting a keyword from the text information may not be possible.

In this regard, the phrase detection module 20B detects phrases by using context that is information on a part other than keywords included in the text information.

For example, the phrase detection module 20B stores, in the storage unit 30, in advance a list of templates including context using target keywords to be output by the keyword detection device 10. The template is, for example, “ [symbol] ______ [symbol] ”. The part other than “______” in the template corresponds to context, and the part “______” is a phrase part. The phrase detection module 20B determines whether context matching any template included in the list of the templates exists in the text information. When the context matching the template exists, the phrase detection module 20B detects, as a phrase, the part corresponding to “______” of the context in the text information.

For example, the phrase detection module 20B prepares in advance a large amount of training data including pairs of sentences including the target keywords to be output by the keyword detection device 10 and labels indicating the locations of the keywords in the sentences. Then, the phrase detection module 20B uses a plurality of the training data and generates in advance a machine learning model with the sentences as input and the labels as output. Then, the phrase detection module 20B inputs the text information, which is the recognition result, to the above machine learning model, and obtains output from the machine learning model, thereby detecting an output label as a phrase.

The similarity calculation module 20C will be explained below.

The similarity calculation module 20C calculates output similarities conforming to the similarities between the keywords included in the keyword list 32 and the phrase detected by the phrase detection module 20B.

For example, the similarity calculation module 20C calculates, as an output similarity, the similarity between the phrase detected by the phrase detection module 20B and reading of each of the keywords included in the keyword list 32.

The case of Japanese will be explained as an example. For example, it is assumed that input information of voice input to the voice recognition module 20A is “ [symbol] [symbol] [symbol] ” It is also assumed that text information, which is the recognition result of the voice data by the voice recognition module 20A, is “ [symbol] [symbol] ”. It is also assumed that the phrase detection module 20B detects a phrase “ [symbol] [symbol] ” from the text information.

Based on these assumptions, three types of similarity calculation methods will be explained as examples.

The first type of similarity calculation method by the similarity calculation module 20C will be first explained.

In the first type of similarity calculation method, the similarity calculation module 20C converts the phrase into reading and calculates an edit distance from the reading of the keyword in the keyword list 32 as a similarity.

Specifically, the similarity calculation module 20C converts the phrase “ [symbol] [symbol] ” into the reading of the phrase “ [symbol] [symbol] ”. Then, the similarity calculation module 20C calculates, as a similarity, an edit distance between the reading of the phrase “ [symbol] [symbol] ” and each of the readings of the keywords registered in the keyword list 32A. The similarity calculation module 20C calculates the similarity by, for example, equation (1) below. Then, the similarity calculation module 20C uses the calculated similarity as an output similarity.

Similarity={(number of characters constituting reading of keyword)−(penalty)}/number of characters constituting reading of keyword) (1)

In equation (1), the penalty represents the number of characters different between the keyword and the phrase.

For example, the reading of the phrase “ [symbol] [symbol] ” includes 15 characters. The similarity calculation module 20C compares the reading of the phrase “ [symbol] [symbol] ” with the reading “ [symbol] [symbol] ” of a certain keyword in the keyword list 32A. By doing so, a total of three characters are different: two characters for the part “ [symbol] ” in the reading of the phrase and the part “ [symbol] ” in the reading of the keyword, and one character for the part “ [symbol] ” in the reading of the phrase and the part “ [symbol] ” in the reading of the keyword. Therefore, the similarity calculation module 20C sets the penalty, which is the number of different characters, to “3”, and calculates (15−3)/15=0.8 as the similarity according to equation (1) above, with the penalty of “3”.

Similarly, the similarity calculation module 20C converts a phrase into the reading of the phrase even when the voice data is in English. Then, the similarity calculation module 20C calculates, as a similarity, an edit distance between the reading of the phrase and each of the readings of the keywords registered in the keyword list 32A. That is, the similarity calculation module 20C calculates the similarity by equation (1) above. Then, the similarity calculation module 20C uses the calculated similarity as an output similarity.

The similarity calculation module 20C may convert each of the reading of the phrase and the reading of the keyword into phonemes, and calculate an edit distance as a similarity in the same manner as described above by using the number of phonemes instead of the number of characters.

Specifically, for example, when considered in units of hiragana, the penalty is “1” when the reading “ [symbol] ” pronounced as “a” is misrecognized as the reading “ [symbol] ” pronounced as “ka” and when the reading “ [symbol] ” is misrecognized as the reading “ [symbol] ” pronounced as “ki”. In the phoneme “a” of the reading “ [symbol] ” and the phoneme “ka” of the reading “ [symbol] ”, the number of different characters is 1 when considered in units of phonemes. On the other hand, in the phoneme “a” of the reading “ [symbol] ” and the phoneme “ki” of the reading “ [symbol] ”, the penalty is 2 when considered in units of phonemes.

Therefore, the similarity calculation module 20C can calculate a similarity with higher accuracy by calculating an edit distance as a similarity by using the number of phonemes instead of the number of characters.

The second type of similarity calculation method by the similarity calculation module 20C will be explained below.

In the second type of similarity calculation method, the similarity calculation module 20C calculates a similarity based on an edit distance and a similarity between characters. Then, the similarity calculation module 20C uses the calculated similarity as an output similarity.

In the first type of similarity calculation method described above, the similarity calculation module 20C uses the number of mismatched characters between a phrase and a keyword as a penalty. However, phrases and keywords may include a mixture of similar and dissimilar characters. Therefore, in the second type of similarity calculation method, the similarity calculation module 20C calculates a similarity considering a similarity between characters by giving a penalty conforming to the similarity between the characters.

The similarity calculation module 20C, for example, prepares in advance a large number of pairs of text information, which is the recognition result of voice data, and correct transcription. Then, the similarity calculation module 20C calculates in advance the percentage of misrecognition between characters for each pair.

For example, it is assumed that a character “ [symbol] ” is correctly recognized 100 times, the character “ [symbol] ” is misrecognized as a character “ [symbol] ” 10 times, and the character “ [symbol] ” is misrecognized as a character “ [symbol] ” 5 times. In this case, a similarity between the character “ [symbol] ” and the character “ [symbol] ” is 10/(100+10+5)=0.087.

In calculating a similarity by an edit distance, the similarity calculation module 20C uses 1−(similarity between characters) as a character similarity penalty when the characters at corresponding positions are different between a phrase and a keyword.

Then, the similarity calculation module 20C calculates the similarity according to equation (2) below. The similarity calculation module 20C uses the calculated similarity as an output similarity.

Similarity={(number of characters constituting reading of keyword)−(penalty×(1−(similarity between characters))}/number of characters constituting reading of keyword (2)

In equation (2), the penalty is the number of different characters between a phrase and a keyword, as in equation (1) above. In equation (2), (1−(similarity between characters)) is a character similarity penalty for each of different characters.

The similarity calculation module 20C uses the similarity based on the edit distance and the similarity between characters as the output similarity, so that a character similarity penalty between characters that are easily misrecognized decreases and a character similarity penalty between characters that are less likely to be misrecognized increases. Therefore, the similarity calculation module 20C can calculate an edit distance considering a similarity between characters as an output similarity.

The third type of similarity calculation method by the similarity calculation module 20C will be explained below.

In the third type of similarity calculation method, the similarity calculation module 20C prepares in advance a large number of pairs of text information, which is the recognition result of voice data, and correct transcription. Then, the similarity calculation module 20C learns in advance, as a machine learning model, a model for calculating a similarity between two phrases: a phrase included in the text information and a phrase included in the correct transcription. The similarity calculation module 20C learns in advance the machine learning model so that the pair of the recognition result of the voice data and the correct transcription has a high similarity and other combinations have a low similarity. Then, the similarity calculation module 20C inputs the pair of the phrase detected by the phrase detection module 20B and the reading of the keyword in the keyword list 32 to the machine learning model, thereby obtaining a similarity as output from the machine learning model. Then, the similarity calculation module 20C uses the obtained similarity as an output similarity.

When an edit distance is used, the similarity calculation module 20C calculates a similarity by comparing one character to another character. On the other hand, when the third type of similarity calculation method is used, the similarity calculation module 20C calculates an output similarity by using a machine learning model in which error-prone patterns are learned in units of several characters. Therefore, the similarity calculation module 20C can calculate a more detailed output similarity by using the third type of similarity calculation method.

The keyword output module 20D will be explained next. The keyword output module 20D outputs keywords in the keyword list 32 according to the output similarity calculated by the similarity calculation module 20C. That is, the keyword output module 20D outputs keywords conforming to the output similarity as correct keywords included in the text information.

Specifically, the keyword output module 20D outputs a predetermined number of keywords in descending order of output similarities, or keywords with output similarities equal to or greater than a threshold, which are included in the keyword list 32.

For example, the keyword output module 20D outputs keywords to an external information processing device communicably connected to the keyword detection device 10. For example, the keyword output module 20D may also output the keywords to a system that is communicably connected to the keyword detection device 10 and performs processing based on the keywords. The keyword output module 20D may also output the keywords to an output unit such as a display or a speaker communicably connected to the control unit 20.

In this way, the keyword output module 20D can output keywords with high output similarities as keywords included in the text information.

The case of Japanese will be explained as an example. For example, it is assumed that input information of voice input to the voice recognition module 20A is “ [symbol] [symbol] [symbol] ”. It is also assumed that text information, which is the recognition result of the voice data by the voice recognition module 20A, is “ [symbol] [symbol] [symbol] ”. It is also assumed that the phrase detection module 20B detects a phrase “ [symbol] [symbol] ” from the text information.

It is also assumed that the similarity calculation module 20C calculates an output similarity of “0.80” as an output similarity between the reading of the phrase “ [symbol] [symbol] ” and the reading of the keyword “ [symbol] [symbol] ” registered in the keyword list 32A. It is also assumed that the similarity calculation module 20C calculates an output similarity of “0.43” as an output similarity between the reading of the phrase “ [symbol] [symbol] ” and the reading of the keyword “ [symbol] ” registered in the keyword list 32A. It is also assumed that the similarity calculation module 20C calculates an output similarity of “0.00” as an output similarity between the reading of the phrase “ [symbol] [symbol] ” and the reading of the keyword “ [symbol] ” registered in the keyword list 32A.

In this case, for example, the keyword output module 20D outputs the notation “ [symbol] [symbol] ” corresponding to the reading of the keyword “ [symbol] [symbol] ” with the highest output similarity, as a correct keyword included in the text information. The keyword output module 20D may output at least one of the reading of a keyword with the highest output similarity and a notation corresponding to the reading.

The case of English will be explained as an example. For example, it is assumed that input information of voice input to the voice recognition module 20A is “show me how to set a hot water storage water temperature”. It is also assumed that text information, which is the recognition result of the voice data by the voice recognition module 20A, is “show me how to set a cotton water strange water temperature”. It is also assumed that the phrase detection module 20B detects a phrase “cotton water strange water temperature” from the text information.

It is also assumed that the similarity calculation module 20C calculates an output similarity “0.79” as an output similarity between the reading of the phrase “cotton water strange water temperature” and the keyword reading of the notation “hot water storage water temperature” registered in the keyword list 32B. It is also assumed that the similarity calculation module 20C calculates an output similarity of “0.43” as an output similarity between the reading of the phrase “cotton water strange water temperature” and the keyword reading of the notation “hot water storage” registered in the keyword list 32B. It is also assumed the similarity calculation module 20C calculates an output similarity of “0.00” as an output similarity between the reading of the phrase “cotton water strange water temperature” and the keyword reading of the notation “how to set” registered in the keyword list 32B.

In this case, for example, the keyword output module 20D outputs at least one of the notation “hot water storage water temperature” corresponding to the reading of the keyword with the highest output similarity and the reading, as a correct keyword included in the text information.

The phrase detection module 20B may detect a plurality of phrases related to keywords from the text information. In this case, the similarity calculation module 20C calculates similarities between the keywords included in the keyword list 32 and each of the detected phrases, in the same manner as above. Then, the similarity calculation module 20C calculates, as output similarities, similarities with a plurality of keywords calculated for each of the phrases.

The phrase detection module 20B may also detect a phrase and the probability that the phrase is a keyword, from the text information. In this case, the similarity calculation module 20C calculates an output similarity conforming to the probability of the phrase and a similarity between the phrase and each of the keywords included in the keyword list 32. For example, the similarity calculation module 20C calculates a result of multiplying the similarity and the probability as the output similarity.

Specifically, the phrase detection module 20B uses a machine learning model to detect the phrase from the text information together with the probability that the phrase is a keyword. Then, the similarity calculation module 20C calculates the similarity between each of the readings of the keywords registered in the keyword list 32 and each of the phrases. Then, the similarity calculation module 20C calculates a value of multiplying the probability of the phrase and the similarity between the phrase and the reading of the keyword as the output similarity of the phrase to the keyword.

The following description will be given on the assumption that input information is voice data in Japanese.

For example, it is assumed that input information is “ [symbol] [symbol] [symbol] ” and text information, which is the recognition result of voice data by the voice recognition module 20A, is “ [symbol] [symbol] [symbol] ”. It is also assumed that the phrase detection module 20B detects a phrase “ [symbol] [symbol] ” and a probability “0.99”, a phrase “ [symbol] ” and a probability “0.95”, and a phrase “ [symbol] ” and a probability “0.99”.

The similarity calculation module 20C calculates a similarity between each of the readings of the keywords registered in the keyword list 32A and each of the phrases. Then, the similarity calculation module 20C calculates a value of multiplying the probability of the phrase and the similarity between the phrase and the reading of the keyword, as the output similarity of the phrase to the keyword.

For example, it is also assumed that input information is “ [symbol] ” and text information, which is the recognition result of voice data by the voice recognition module 20A, is “ [symbol] ”. It is also assumed that the phrase detection module 20B detects a phrase “ [symbol] ” and a probability “0.99”, and a phrase “ [symbol] ” and a probability “0.95”.

It is also assumed that the keyword of the reading “ [symbol] ” of a notation “ [symbol] ” and the keyword of the reading “ [symbol] ” of a notation “ [symbol] ” are registered in the keyword list 32A.

It is also assumed that the similarity calculation module 20C calculates “0.60” as a similarity between the reading of the phrase “ [symbol] ” and the reading “ [symbol] ” of the keyword. In this case, the similarity calculation module 20C calculates “0.59”, which is a value of the probability “0.99” of the phrase “ [symbol] ”×similarity “0.60”, as an output similarity between the phrase “ [symbol] ” and the reading “ [symbol] ” of the keyword.

It is also assumed that the similarity calculation module 20C calculates “0.67” as a similarity between the reading of the phrase “ [symbol] ” and the reading “ [symbol] ” of the keyword. In this case, the similarity calculation module 20C calculates “0.63”, which is a value of the probability “0.94” of the phrase “ [symbol] ”×similarity “0.67”, as an output similarity between the phrase “ [symbol] ” and the reading “ [symbol] ” of the keyword.

In this way, the similarity calculation module 20C calculates an output similarity conforming to a similarity and a probability, thereby obtaining the following effects. Specifically, even when at least a part of a plurality of phrases output by the phrase detection module 20B includes an error, a value of an output similarity of a phrase closer to a correct keyword can be increased.

Instead of a value of multiplying the probability of a phrase and a similarity between the phrase and the reading of a keyword, the similarity calculation module 20C may also calculate the sum of the probability and the similarity as an output similarity.

The similarity calculation module 20C may also calculate, for each of the keywords in the keyword list 32, an output similarity by using a similarity with the phrase, the probability that the phrase is a keyword, and a weighted value for at least one of the similarity and the probability.

For example, it is assumed that a setting has been made in advance that emphasizes probability over similarity. In this case, the similarity calculation module 20C may calculate an output similarity by equation (3) below.

(Probability)×(Similarity)^{0.9}=output similarity (3)

In this way, the similarity calculation module 20C may calculate an output similarity by performing weighting to reduce the similarity. In equation (3), the power “0.9” is used as a weighted value for reducing the similarity, but the weighted value is not limited to this value.

Similarly, the similarity calculation module 20C may also calculate an output similarity by using a weighted value that emphasizes similarity over probability. Similarly, the similarity calculation module 20C may also calculate an output similarity by assigning a weight value of a predetermined ratio to each of the probability and the similarity.

The phrase detection module 20B may detect a plurality of phrases having different numbers of characters related to keywords from the text information. The similarity calculation module 20C may use, as the phrases having different numbers of characters, the phrases detected by the phrase detection module 20B and expanded/shrunken phrases obtained by performing at least one of expansion and shrinkage on the phrases by a predetermined number of characters in the text information.

It is assumed that the keywords registered in the keyword list 32 are keywords including other keywords.

The case of Japanese will be explained as an example. For example, it is assumed that a keyword “ [symbol] [symbol] ” and a keyword “ [symbol] ” are registered in the keyword list 32. In this case, the keyword “ [symbol] ” is included in the keyword “ [symbol] [symbol] ”. In such a case, a misrecognized keyword and other misrecognized keywords included in the keyword may be incorrectly detected from text information including phrases related to these keywords.

The case of English will be explained as an example. For example, it is assumed that a keyword “hot water storage water temperature” and a keyword “hot water storage” are registered in the keyword list 32. In this case, the keyword “hot water storage” is included in the keyword “hot water storage water temperature”. In such a case, a misrecognized keyword and other misrecognized keywords included in the keyword may be incorrectly detected from text information including phrases related to these keywords.

In this regard, the similarity calculation module 20C may calculate output similarities with a weighted value for reducing the similarities between the keywords in the keyword list 32 and each of the phrases as the number of characters in the keyword decreases. That is, the similarity calculation module 20C may give a higher penalty to a keyword with fewer characters so that a keyword that is as long as possible is output from the keyword output module 20D.

The following description will be given on the assumption that voice, which is input information, is Japanese voice.

For example, it is assumed that input information is “ [symbol] [symbol] ” and text information, which is the recognition result of voice data by the voice recognition module 20A, is “ [symbol] [symbol] ”. It is also assumed that the phrase detection module 20B detects, as phrases, a phrase “ [symbol] ” and a probability “0.99” and a phrase “ [symbol] [symbol] ” and a probability “0.95”.

It is also assumed that the keyword of the reading “ [symbol] [symbol] [symbol] ” of the notation “ [symbol] [symbol] ” and the keyword of the reading “ [symbol] ” of the notation “ [symbol] ” are registered in the keyword list 32A.

It is also assumed that the similarity calculation module 20C calculates “1.0” as a similarity between the reading “ [symbol] ” of the phrase “ [symbol] ” and the keyword reading “ [symbol] ” of the notation “ [symbol] ”.

It is also assumed that the similarity calculation module 20C calculates “0.95” as a similarity between the reading “ [symbol] [symbol] [symbol] ” of the phrase “ [symbol] [symbol] ” and the keyword reading “ [symbol] [symbol] [symbol] ” of the notation “ [symbol] [symbol] ”.

In this case, since the number of characters of the keyword of the reading “ [symbol] [symbol] [symbol] ” is 20 and the number of characters of the keyword of the reading “ [symbol] ” is 3, the similarity calculation module 20C gives, for example, a penalty corresponding to 17 characters, which is the difference between 20 characters and 3 characters, to the short keyword “ [symbol] ”.

Specifically, the similarity calculation module 20C calculates an output similarity between the reading “ [symbol] ” of the phrase “ [symbol] ” and the keyword reading “ [symbol] ” of the notation “ [symbol] ” by equation (4) below.

$$Output similarity = similarity \times probability \times penalty = 1. \times 0.99 \times {0.99}^{17} = 0.76 \qquad ( 4 )$$

In equation (4), “0.99¹⁷” corresponds to the penalty corresponding to 17 characters.

The similarity calculation module 20C also calculates an output similarity between the reading of the phrase “ [symbol] [symbol] ” and the keyword reading of the notation “ [symbol] [symbol] ” by equation (5) below.

$$Output similarity = similarity \times probability \times penalty = 0.95 \times 0.95 = 0.9 \qquad ( 5 )$$

In this way, the similarity calculation module 20C may calculate an output similarity with a higher penalty given to a keyword with fewer characters so that a keyword that is as long as possible is output from the keyword output module 20D.

An example of the flow of information processing performed by the keyword detection device 10 will be explained below.

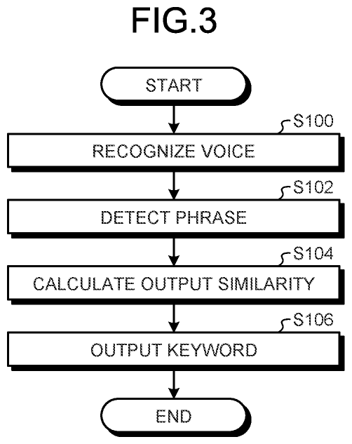

FIG. 3 is a flowchart illustrating an example of the flow of information processing performed by the keyword detection device 10.

The voice recognition module 20A acquires voice data as input information, and outputs text information as the recognition result of the voice data (step S100).

The phrase detection module 20B detects a phrase related to a keyword from the text information output at step S100 (step S102).

The similarity calculation module 20C calculates output similarities conforming to similarities between the keywords included in the keyword list 32 and the phrase detected at step S102 (step S104).

The keyword output module 20D outputs keywords in the keyword list 32 according to the output similarities calculated at step S104 (step S106). Then, the present routine is ended.

As explained above, the keyword detection device 10 of the present embodiment includes the phrase detection module 20B, the similarity calculation module 20C, and the keyword output module 20D. The phrase detection module 20B detects a phrase related to a keyword from text information that is the recognition result of input information represented in a predetermined input form. The similarity calculation module 20C calculates output similarities conforming to similarities between the phrase and the keywords included in the keyword list 32 in which, for each of the keywords, keyword notation of the corresponding keyword is associated with keyword form information representing the corresponding keyword in an input form. The keyword output module 20D outputs keywords in the keyword list 32 according to the output similarities.

The related art is based on the assumption that a keyword alone is input as input information, and when input information such as a natural sentence including a keyword is input, specifying the location of the keyword included in the input information has been difficult. In the related art of specifying the location of the keyword by retrieving a phoneme sequence of a correct keyword from a phoneme sequence of a voice recognition result, specifying the location of the keyword has been difficult when an error exists in the phoneme. That is, in the related art, when the recognition result includes an error, outputting the correct keyword has been difficult.

On the other hand, in the keyword detection device 10 of the present embodiment, the phrase detection module 20B detects a phrase related to a keyword from text information that is the recognition result of input information. Then, the keyword output module 20D outputs keywords in the keyword list 32 according to output similarities conforming to similarities between keywords included in the keyword list 32 and the phrase.

In this way, the keyword detection device 10 of the present embodiment outputs a keyword conforming to an output similarity between the keyword and a phrase related to the keyword. Therefore, even when the input information is a natural sentence including a keyword or even when the text information, which is the recognition result of the input information, includes an error, the keyword detection device 10 of the present embodiment can output a correct keyword.

Consequently, even when the recognition result of the input information includes an error, the keyword detection device 10 of the present embodiment can output a correct keyword.

### Second Embodiment

A second embodiment will be explained below. In the description of the second embodiment, the same reference numerals are assigned to the same parts as in the above embodiment, a description thereof will be omitted, and parts different from those of the above embodiment will be explained.

In the present embodiment, as in the above embodiment, an example in which an input form is voice and input information is voice data will be explained.

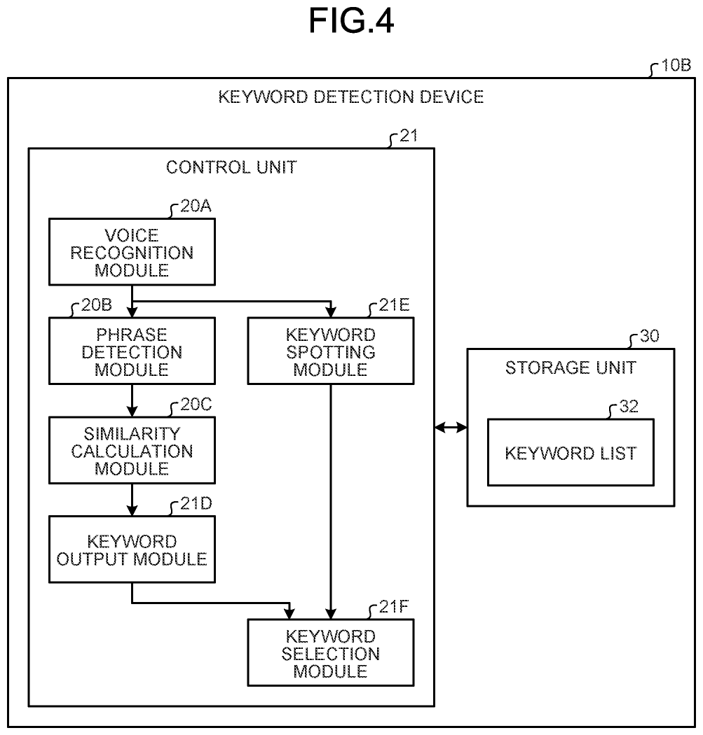

FIG. 4 is a functional block diagram of an example of a keyword detection device 10B of the present embodiment.

The keyword detection device 10B includes a control unit 21 and the storage unit 30. The control unit 21 and the storage unit 30 are connected to be able to exchange data and signals. The storage unit 30 is the same as in the above embodiment.

The control unit 21 performs information processing in the keyword detection device 10B. The control unit 21 includes the voice recognition module 20A, the phrase detection module 20B, the similarity calculation module 20C, a keyword output module 21D, a keyword spotting module 21E, and a keyword selection module 21F. That is, the control unit 21 is the same as the control unit 20 of the above embodiment, except that the control unit 21 includes the keyword output module 21D instead of the keyword output module 20D and further includes the keyword spotting module 21E and the keyword selection module 21F.

As in the keyword output module 20D, the keyword output module 21D outputs keywords in the keyword list 32 according to the output similarities calculated by the similarity calculation module 20C. The keyword output module 21D outputs keywords in the keyword list 32 conforming to the output similarities to the keyword selection module 21F as first keywords.

The keyword spotting module 21E extracts keywords included in the keyword list 32 from the text information as second keywords. That is, the keyword spotting module 21E extracts, as the second keywords, keywords included in the text information that is the recognition result of the input information and matching keywords registered in the keyword list 32.

The case of Japanese will be explained as an example. For example, it is assumed that input information of voice input to the voice recognition module 20A is “ [symbol] [symbol] [symbol] ” . It is also assumed that the text information, which is the recognition result of voice data by the voice recognition module 20A, is “ [symbol] [symbol] [symbol] ”. It is also assumed that the phrase detection module 20B detects a phrase “ [symbol] [symbol] ” from the text information.

In this case, the keyword spotting module 21E extracts “ [symbol] ” and “ [symbol] ” matching the keywords registered in the keyword list 32A from the text information “ [symbol] [symbol] [symbol] ” that is the recognition result of the voice data.

The keyword selection module 21F selects at least one of the first keywords, which are the keywords output from the keyword output module 21D, and the second keywords extracted by the keyword spotting module 21E. Then, the keyword selection module 21F outputs the selected keywords as correct keywords included in the text information.

The case of Japanese will be explained as an example. For example, it is assumed that the keyword spotting module 21E extracts “ [symbol] ” and “ [symbol] ” as second keywords from the text information “ [symbol] [symbol] [symbol] ” that is the recognition result of voice data. It is also assumed that the phrase detection module 20B detects a phrase “ [symbol] [symbol] ” from the text information. It is also assumed that the keyword output module 21D outputs a first keyword “ [symbol] [symbol] ” according to the output similarity calculated by the similarity calculation module 20C.

In this case, the keyword selection module 21F selects and outputs at least one of the first keyword “ [symbol] [symbol] ” output from the keyword output module 21D and the second keywords “ [symbol] ” and “ [symbol] ” extracted by the keyword spotting module 21E.

For example, the keyword selection module 21F selects both “ [symbol] [symbol] ” and “ [symbol] ” for keywords respectively detected at non-overlapping locations in the text information. For a plurality of keywords detected from overlapping locations in the text information, the keyword selection module 21F may select at least one keyword. For example, “ [symbol] ” and “ [symbol] [symbol] ” are detected from overlapping locations in the text information. Since it is presumed that the voice uttered by a user is one of them, it is preferable to limit the number of keywords detected from overlapping locations to one. However, depending on post-stage processing, it may not be necessary to limit the number to one. Therefore, for a plurality of keywords detected from overlapping locations in the text information, the keyword selection module 21F may select at least one keyword from the keywords, or may select all the keywords.

Keywords with the same reading but different notations may be difficult to be distinguishably identified by voice recognition. In the case of Japanese, for example, a keyword with the reading “ [symbol] ” and the notation “ [symbol] ” and a keyword with the reading “ [symbol] ” and the notation “ [symbol] ” may be difficult to be distinguishably identified by voice recognition. In such a case, the keyword selection module 21F may not select only one keyword from one or a plurality of first keywords and one or a plurality of second keywords. For example, a subsequent functional unit or the like appropriately performs a process of limiting the number of keywords to one.

The keyword selection module 21F outputs the selected keyword. For example, the keyword selection module 21F outputs the selected keyword to an external information processing device communicably connected to the keyword detection device 10B. For example, the keyword selection module 21F may also output the keyword to a system that is communicably connected to the keyword detection device 10B and performs processing based on the keyword. The keyword selection module 21F may also output the keyword to an output unit such as a display or a speaker communicably connected to the control unit 21.

An example of the flow of information processing performed by the keyword detection device 10B will be explained below.

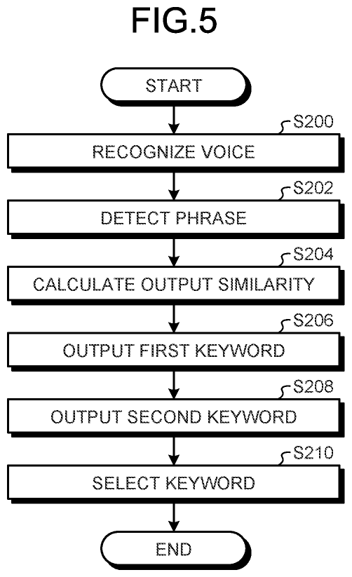

FIG. 5 is a flowchart illustrating an example of the flow of information processing performed by the keyword detection device 10B.

Processes of step S200 to step S204 are the same as the processes of step S100, step S102, and step S104 in the first embodiment described above (see FIG. 3).

Specifically, the voice recognition module 20A acquires voice data as input information, and outputs text information as the recognition result of the voice data (step S200). The phrase detection module 20B detects a phrase related to a keyword from the text information output at step S200 (step S202). The similarity calculation module 20C calculates output similarities conforming to similarities between the keywords included in the keyword list 32 and the phrase detected at step S202 (step S204).

The keyword output module 21D outputs keywords in the keyword list 32 as first keywords according to the output similarities calculated at step S204 (step S206).

The keyword spotting module 21E extracts, as second keywords, keywords included in the keyword list 32 from the text information output at step S200 (step S208).

The keyword selection module 21F selects at least one of the first keywords, which are the keywords output from the keyword output module 21D at step S206, and the second keywords extracted at step S208 (step S210). Subsequently, the keyword selection module 21F outputs the selected keyword as a correct keyword included in the text information and ends the present routine.

As explained above, in the keyword detection device 10B of the present embodiment, the keyword spotting module 21E extracts keywords included in the keyword list 32 from the text information as second keywords. The keyword selection module 21F selects at least one of the first keywords, which are the keywords output from the keyword output module 21D, and the second keywords extracted by the keyword spotting module 21E. Then, the keyword selection module 21F outputs the selected keyword as a correct keyword included in the text information.

Therefore, the keyword detection device 10B of the present embodiment can output a more correct keyword from input information, in addition to the effects of the above embodiment.

### Third Embodiment

A third embodiment will be explained next. In the description of the third embodiment, the same reference numerals are assigned to the same parts as in the above embodiments, a description thereof will be omitted, and parts different from those of the above embodiments will be explained.

In the present embodiment, as in the above embodiments, an example in which an input form is voice and input information is voice data will be explained.

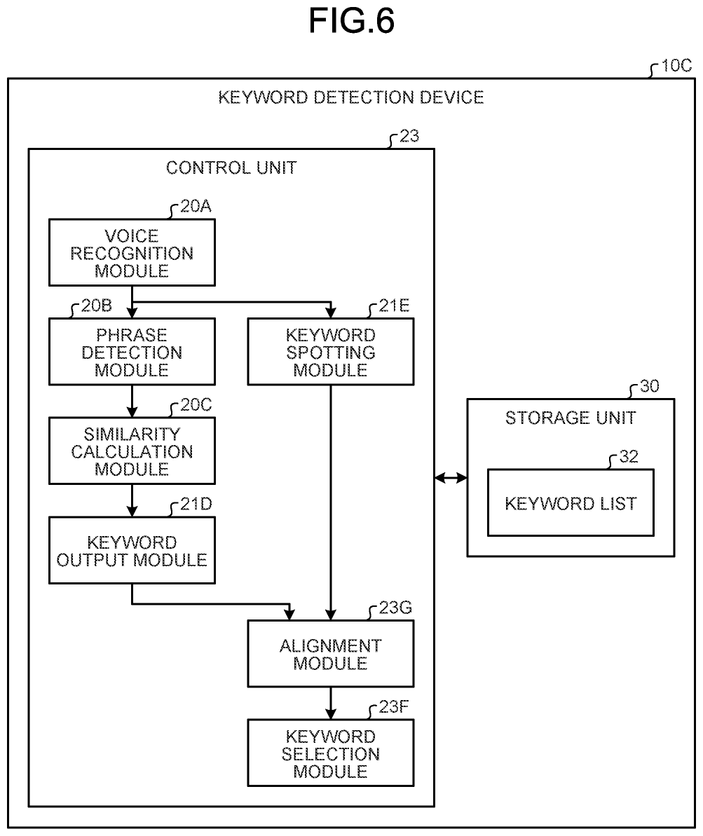

FIG. 6 is a functional block diagram of an example of a keyword detection device 10C of the present embodiment.

The keyword detection device 10C includes a control unit 23 and the storage unit 30. The control unit 23 and the storage unit 30 are connected to be able to exchange data and signals. The storage unit 30 is the same as in the above embodiments.

The control unit 23 performs information processing in the keyword detection device 10C. The control unit 23 includes the voice recognition module 20A, the phrase detection module 20B, the similarity calculation module 20C, the keyword output module 21D, the keyword spotting module 21E, an alignment module 23G, and a keyword selection module 23F. That is, the control unit 23 is the same as the control unit 21 of the above embodiment, except that the control unit 23 includes the keyword selection module 23F instead of the keyword selection module 21F and further includes the alignment module 23G.

In the present embodiment, the voice recognition module 20A acquires voice data as input information, and outputs a plurality of pieces of text information as the recognition result of one voice data. That is, in the present embodiment, the voice recognition module 20A outputs a plurality of pieces of text information as the recognition result of the voice data that is the input information.

The phrase detection module 20B detects phrases from each of the pieces of text information in the same manner as in the above embodiments. As in the above embodiments, the similarity calculation module 20C calculates the output similarities conforming to the similarities between the keywords in the keyword list 32 and the phrase detected by the phrase detection module 20B. As in the above embodiment, the keyword output module 21D outputs keywords in the keyword list 32 conforming to the output similarities calculated by the similarity calculation module 20C. As in the above embodiment, the keyword output module 21D selects keywords in the keyword list 32 according to the output similarities as first keywords. Then, the keyword output module 21D outputs the first keywords to the alignment module 23G.

The keyword spotting module 21E extracts keywords included in the keyword list 32 from each of the pieces of text information as second keywords.

With respect to each of one or a plurality of first keywords and one or a plurality of second keywords, the alignment module 23G specifies a group of a plurality of keywords in which at least some of corresponding regions in the text information overlap. The corresponding region in the text information means a position and a range in the text information. When the text information is the recognition result of the voice data, the corresponding region is represented by an utterance period or the like defined by an utterance start time and an utterance end time in the text information.

The case of Japanese will be explained as an example. For example, it is assumed that the voice recognition module 20A outputs text information, which are three voice recognition results of “ [symbol] [symbol] ”, “ [symbol] [symbol] ” and “ [symbol] [symbol] ” from input information that is one voice data.

It is also assumed that the following keywords are output from each of the pieces of text information by the keyword output module 21D and the keyword spotting module 21E as first keywords and second keywords.

Text information: “ [symbol] [symbol] ”
No keyword output.
Word included in text information/corresponding region
: [symbol] /corresponding region (utterance start time: 2, utterance end time: 5)
: [symbol] /corresponding region (utterance start time: 5, utterance end time: 12)
: [symbol] /corresponding region (utterance start time: 12, utterance end time: 17)
: [symbol] /corresponding region (utterance start time: 17, utterance end time: 21)
: [symbol] /corresponding region (utterance start time: 21, utterance end time: 28)

Text information: “ [symbol] [symbol] ”
Keyword/corresponding region: “ [symbol] [symbol] ” /corresponding region (utterance start time: 0, utterance end time: 21)
Word included in text information/corresponding region
: [symbol] /corresponding region (utterance start time: 0, utterance end time: 5)
: [symbol] /corresponding region (utterance start time: 5, utterance end time: 12)
: [symbol] /corresponding region (utterance start time: 12, utterance end time: 17)
: [symbol] /corresponding region (utterance start time: 17, utterance end time: 21)
: [symbol] /corresponding region (utterance start time: 21, utterance end time: 22)
: [symbol] /corresponding region (utterance start time: 22, utterance end time: 28)

Text information: “ [symbol] [symbol] ” ,
Keyword/corresponding region: “ [symbol] ”/corresponding region (utterance start time: 0, utterance end time: 12)
: [symbol] /corresponding region (utterance start time: 0, utterance end time: 5)
: [symbol] /corresponding region (utterance start time: 5, utterance end time: 12)
: [symbol] /corresponding region (utterance start time: 12, utterance end time: 17)
: [symbol] /corresponding region (utterance start time: 17, utterance end time: 21)
: [symbol] /corresponding region (utterance start time: 21, utterance end time: 28)

In this case, the alignment module 23G specifies, for each of the pieces of text information, the utterance start time and the utterance end time in the text information of each of a plurality of words included in the text information, thereby specifying a corresponding region in the text information for each of the words. Then, the alignment module 23G determines the utterance start time and the utterance end time of each keyword derived from the text information by using the corresponding region of each word, thereby specifying a corresponding region.

The alignment module 23G uses corresponding regions specified for each of keywords that are the first keywords and the second keywords, and specifies a group of keywords in which at least some of utterance periods, which are corresponding regions, overlap.

The keyword selection module 23F selects at least one of a plurality of keywords belonging to the same group specified by the alignment module 23G and at least one of one or a plurality of keywords not belonging to the group, among one or a plurality of first keywords output from the keyword output module 21D and one or a plurality of second keywords output from the keyword spotting module 21E.

For example, the keyword selection module 23F selects at least one of the second keywords extracted by the keyword spotting module 21E and a predetermined number of first keywords in descending order of output similarities or first keywords with output similarities equal to or greater than a threshold, among a plurality of first keywords belonging to the same group and output from the keyword output module 21D.

For example, the keyword selection module 23F may also select keywords from keywords detected from text information including keywords with high output similarities among keywords detected from different text information.

Then, the keyword selection module 23F outputs the selected keywords. For example, the keyword selection module 23F outputs the selected keywords to an external information processing device communicably connected to the keyword detection device 10C. For example, the keyword selection module 23F may also output the keywords to a system that is communicably connected to the keyword detection device 10C and performs processing based on the keywords. The keyword selection module 23F may also output the keywords to an output unit such as a display or a speaker communicably connected to the control unit 23.

An example of the flow of information processing performed by the keyword detection device 10C will be explained below.

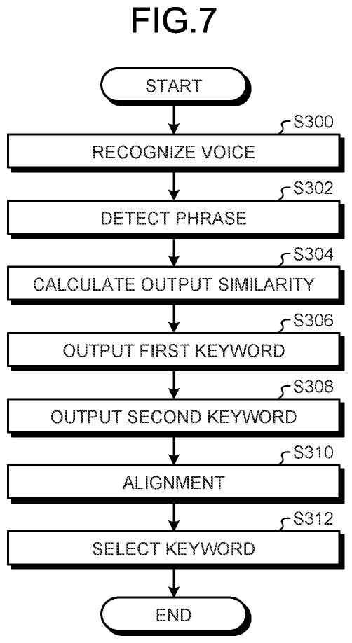

FIG. 7 is a flowchart illustrating an example of the flow of information processing performed by the keyword detection device 10C.

Processes of step S300 to step S308 are the same as the processes of step S200 to step S208 of the above second embodiment (see FIG. 5).

Specifically, the voice recognition module 20A acquires voice data as input information and outputs a plurality of pieces of text information as the recognition result of the voice data (step S300). The phrase detection module 20B detects a phrase related to a keyword from each of the pieces of text information output at step S300 (step S302). The similarity calculation module 20C calculates output similarities conforming to similarities between the keywords included in the keyword list 32 and the phrase detected at step S302 (step S304).

The keyword output module 21D outputs keywords in the keyword list 32 as first keywords according to the output similarities calculated at step S304 (step S306). The keyword spotting module 21E extracts keywords included in the keyword list 32 as second keywords from the pieces of text information output at step S300 (step S308).

With respect to each of the first keywords output at step S306 and the second keywords output at step S308, the alignment module 23G specifies a group of a plurality of keywords in which at least some of corresponding regions in the text information overlap (step S310).

The keyword selection module 23F selects at least one of a plurality of keywords belonging to the same group specified by the alignment module 23G and at least one of one or a plurality of keywords not belonging to the group, among one or a plurality of first keywords output from the keyword output module 21D and one or a plurality of second keywords output from the keyword spotting module 21E (step S312). Subsequently, the keyword selection module 23F outputs the selected keywords as correct keywords included in the text information and ends the present routine.

As explained above, in the keyword detection device 10C of the present embodiment, the alignment module 23G specifies, for each of the first keywords and the second keywords, a group of a plurality of keywords in which at least some of corresponding regions in the text information overlap. The keyword selection module 23F selects at least one of a plurality of keywords belonging to the same group specified by the alignment module 23G and at least one of one or a plurality of keywords not belonging to the group, among one or a plurality of first keywords output from the keyword output module 21D and one or a plurality of second keywords output from the keyword spotting module 21E. Then, the keyword selection module 23F outputs the selected keywords as correct keywords included in the text information.

Therefore, the keyword detection device 10C of the present embodiment can output a more correct keyword from input information, in addition to the effects of the above embodiments.

### Fourth Embodiment

A fourth embodiment will be explained below. In the description of the fourth embodiment, the same reference numerals are assigned to the same parts as in the above embodiments, a description thereof will be omitted, and parts different from those of the above embodiments will be explained.

In the present embodiment, as in the above embodiments, an example in which an input form is voice and input information is voice data will be explained.

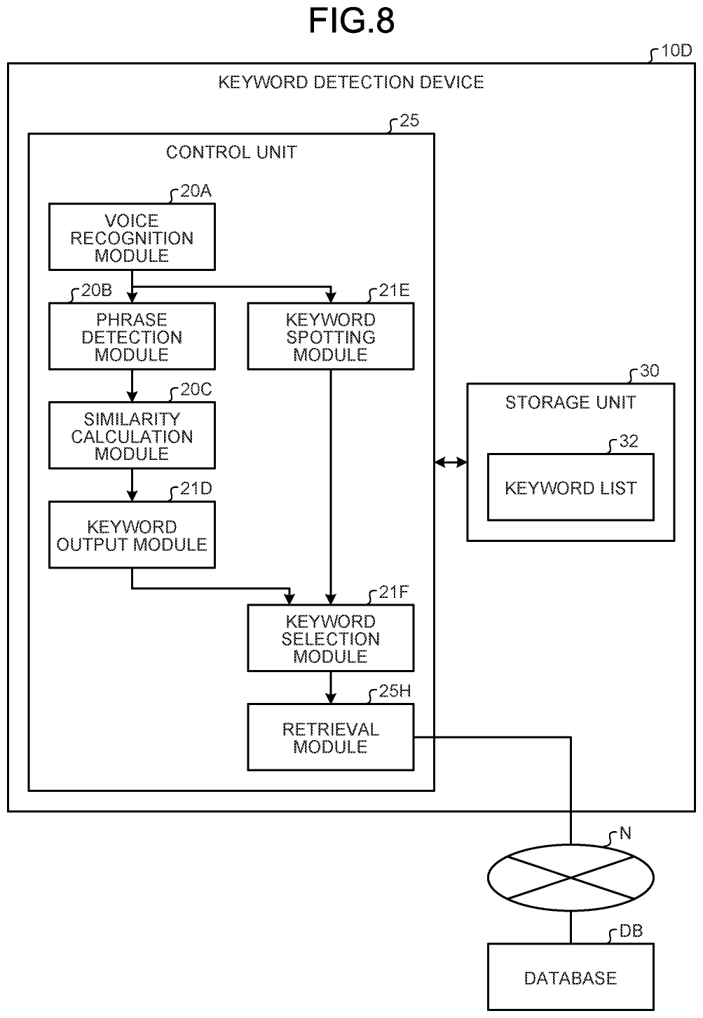

FIG. 8 is a functional block diagram of an example of a keyword detection device 10D of the present embodiment.

The keyword detection device 10D includes a control unit 25 and the storage unit 30. The control unit 25 and the storage unit 30 are connected to be able to exchange data and signals. The storage unit 30 is the same as in the above embodiments.

The control unit 25 performs information processing in the keyword detection device 10D. The control unit 25 includes the voice recognition module 20A, the phrase detection module 20B, the similarity calculation module 20C, the keyword output module 21D, the keyword spotting module 21E, the keyword selection module 21F, and a retrieval module 25H. That is, the control unit 25 is the same as the control unit 21 of the above embodiment, except that the control unit 25 further includes the retrieval module 25H.

The retrieval module 25H generates a retrieval query by combining keywords, in which corresponding regions in the text information overlap, with an OR condition and combining keywords, in which the corresponding regions in the text information do not overlap, with an AND condition, among the keywords selected by the keyword selection module 21F. Then, the retrieval module 25H searches a database DB by using the generated retrieval query.

The database DB is communicably connected to the keyword detection device 10D via a network N or the like. One or more contents are stored in the database DB. Each content holds text information such as name and description.

The database DB is installed, for example, in an external server or the like communicatively connected to the keyword detection device 10.

The external server is, for example, an information processing device that manages various data handled on the network N. Examples of the external server include a social networking service (SNS) server, a management server, a retrieval server, and the like. The SNS server is a server that manages data handled by SNS. Examples of the management server include a server managed by a mass media organization such as a newspaper and a radio station, a server that manages various information created or transmitted by users and information on the users, and the like. An example of the retrieval server includes a server that manages a retrieval site such as a website that provides a retrieval function. FIG. 8 schematically illustrates one database DB. However, the keyword detection device 10D may be configured to be communicably connected to one or a plurality of databases DB.

The case of Japanese will be explained as an example. For example, it is assumed that text information, which is the recognition result of voice data by the voice recognition module 20A, is “ [symbol] [symbol] ”. It is also assumed that the keyword selection module 21F selects “ [symbol] ”, “ [symbol] ”, and “ [symbol] ” as keywords.

The keyword selection module 21F assigns a group ID to each of the keywords. Specifically, the keyword selection module 21F assigns the same group ID to keywords detected from regions where corresponding regions in the text information overlap. For example, it is assumed that the keyword selection module 21F assigns a group ID “1” to the keyword “ [symbol] ” and a group ID “2” to the keyword “ [symbol] ” and the keyword “ [symbol] ”.

In this case, the keyword selection module 21F generates a retrieval query by combining the keywords assigned the same group ID with an OR condition and combining the keywords assigned different group IDs with an AND condition.

Specifically, the keyword selection module 21F generates the following retrieval query.

retrieval query:
select * from database where name like “ [symbol] A” AND (name like “ [symbol] ” OR name like “ [symbol] ”)

Then, by using the generated retrieval query, the keyword selection module 21F can retrieve, from the database DB, contents including the keyword “ [symbol] ” or “ [symbol] ” and the keyword “ [symbol] ”.

The voice recognition module 20A is not able to distinguishably recognize the words “ [symbol] ” and “ [symbol] ” having the same reading. Therefore, the keyword selection module 21F generates a retrieval query by combining, with an OR condition, keywords detected from regions where corresponding regions in the text information overlap, the keywords being output from the keyword output module 21D and the keyword spotting module 21E. When there is only one retrieved content, the retrieval module 25H may output the one retrieved content to an output unit such as a display. When there are a plurality of retrieved contents, the retrieval module 25H may output the contents to an output unit such as a display. The retrieval module 25H may also output, to a display, a message or the like requesting selection input of one content, and request a user to selectively input one content.

An example of the flow of information processing performed by the keyword detection device 10D will be explained below.

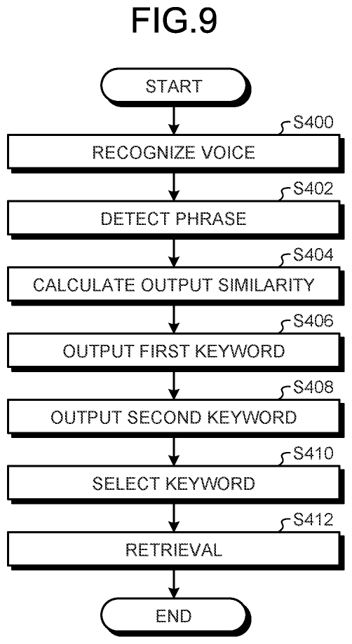

FIG. 9 is a flowchart illustrating an example of the flow of information processing performed by the keyword detection device 10D.

Processes of step S400 to step S410 are the same as the processes of step S200 to step S210 of the above second embodiment (see FIG. 5).

Specifically, the voice recognition module 20A acquires voice data as input information, and outputs text information as the recognition result of the voice data (step S400). The phrase detection module 20B detects a phrase related to a keyword from the text information output at step S400 (step S402). The similarity calculation module 20C calculates output similarities conforming to similarities between the keywords included in the keyword list 32 and the phrase detected at step S402 (step S404).

The keyword output module 21D outputs keywords in the keyword list 32 as first keywords according to the output similarities calculated at step S404 (step S406). The keyword spotting module 21E extracts, as second keywords, keywords included in the keyword list 32 from the text information output at step S400 (step S408). The keyword selection module 21F selects at least one of the first keywords, which are the keywords output from the keyword output module 21D at step S406, and the second keywords extracted at step S408 (step S410).

The retrieval module 25H generates a retrieval query by combining keywords, in which corresponding regions in the text information overlap, with an OR condition and combining keywords, in which the corresponding regions in the text information do not overlap, with an AND condition, among the keywords selected by the keyword selection module 21F. Then, the retrieval module 25H searches the database DB by using the generated retrieval query (step S412). Then, the present routine is ended.

As explained above, the keyword detection device 10D of the present embodiment further includes the retrieval module 25H. The retrieval module 25H generates a retrieval query by combining keywords, in which corresponding regions in the text information overlap, with an OR condition and combining keywords, in which the corresponding regions in the text information do not overlap, with an AND condition, among the keywords selected by the keyword selection module 21F. Then, the retrieval module 25H searches a database DB by using the generated retrieval query.

Therefore, the keyword detection device 10D of the present embodiment can efficiently retrieve information on correct keywords from input information, in addition to the effects of the above embodiments.

### Fifth Embodiment

A fifth embodiment will be explained below. In the description of the fifth embodiment, the same reference numerals are assigned to the same parts as in the above embodiments, a description thereof will be omitted, and parts different from those of the above embodiments will be explained.

In the present embodiment, as in the above embodiments, an example in which an input form is voice and input information is voice data will be explained.

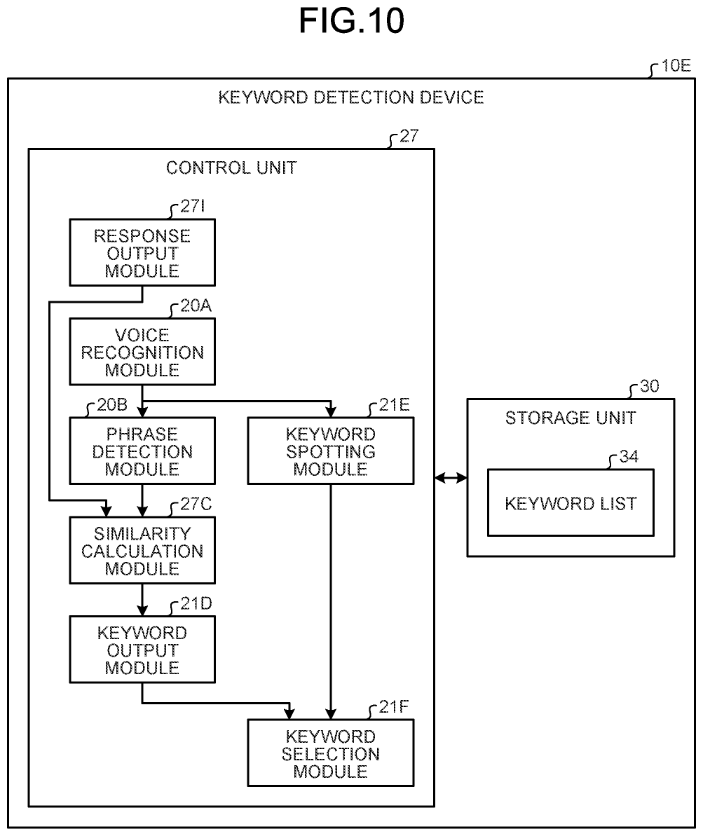

FIG. 10 is a functional block diagram of an example of a keyword detection device 10E of the present embodiment.

The keyword detection device 10E includes a control unit 27 and the storage unit 30. The control unit 27 and the storage unit 30 are connected to be able to exchange data and signals. The storage unit 30 stores a keyword list 34 in advance instead of the keyword list 32 used in the above embodiments.

The keyword list 34 is a list in which, for each of a plurality of keywords, keyword notation of the keyword, keyword form information representing the keyword in an input form, and an attribute of the keyword are associated with one another. The attributes indicate the type of the keyword.

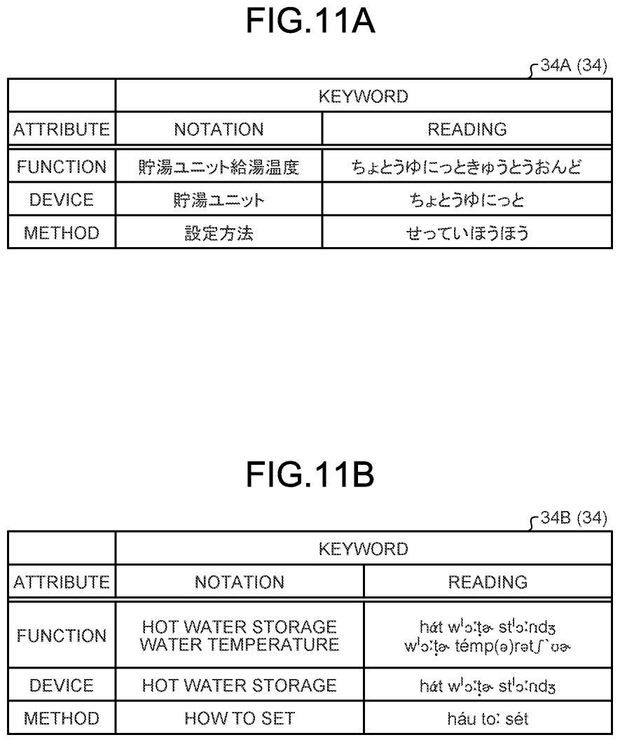

FIG. 11A is a schematic diagram illustrating an example of the data structure of a keyword list 34A. The keyword list 34A is an example of the keyword list 34 when voice, which is input information, is Japanese voice. The keyword list 34A illustrates an example in which notation, reading, and attributes are registered in association with one another for each of three keywords. Although two or four or more keywords are registered in the keyword list 34A, FIG. 11A illustrates some of the keywords for the sake of simplicity.

FIG. 11B is a schematic diagram illustrating an example of the data structure of a keyword list 34B. The keyword list 34B is an example of the keyword list 34 when voice, which is input information, is English voice. The keyword list 34B illustrates an example in which notation and reading are registered for each of three keywords in association with each other. Although two or four or more keywords are registered in the keyword list 34B, FIG. 11B illustrates some of the keywords for the sake of simplicity.

The description is continued by referring back to FIG. 10. The control unit 27 performs information processing in the keyword detection device 10E. The control unit 27 includes the voice recognition module 20A, the phrase detection module 20B, a similarity calculation module 27C, the keyword output module 21D, the keyword spotting module 21E, the keyword selection module 21F, and a response output module 271. The control unit 27 is the same as the control unit 21 of the above embodiment, except that the control unit 27 includes the similarity calculation module 27C instead of the similarity calculation module 20C and further includes the response output module 271.

The response output module 271 outputs a response message including the attributes registered in the keyword list 34. The response message is a message that is generated according to the processing result of a user's utterance and prompts the user to utter the next voice. For example, the response output module 271 outputs the response message to an output unit such as a speaker or a display electrically connected to the control unit 27.

In the case of Japanese, for example, the response output module 271 outputs a response message “ [symbol] ” including an attribute “ [symbol] ” that means “FUNCTION”. It is assumed that input information that is input after the output of the response message including the attribute “ [symbol] ” includes a word corresponding to the attribute “ [symbol] ”. In this case, for example, the input information is likely to include the name of the “ [symbol] ”.

In this regard, the similarity calculation module 27C calculates an output similarity conforming to a similarity between a phrase detected from text information, which is the recognition result of input information that is input after the response message is output from the response output module 271, and reading, which is keyword form information corresponding to the attributes included in the response message in the keyword list 34. It suffices if the input information that is input after the response message is output from the response output module 271 is input information that is input within a predetermined period of time from the output of the response message.

Specifically, the similarity calculation module 27C specifies keywords in the keyword list 34 corresponding to attributes included in a response message output immediately before. Then, the similarity calculation module 27C calculates output similarities between one or a plurality of specified keywords and the phrase detected by the phrase detection module 20B, in the same manner as the similarity calculation module 20C of the above embodiments.

An example of the flow of information processing performed by the keyword detection device 10E will be explained next.

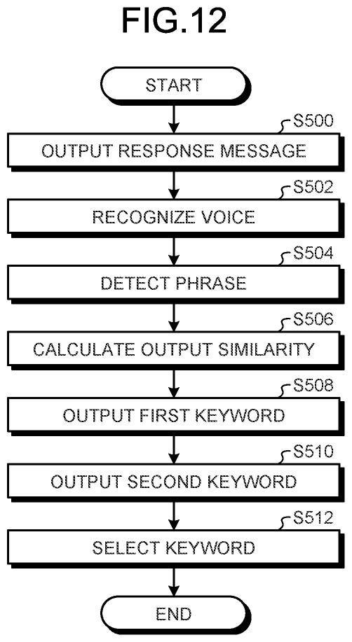

FIG. 12 is a flowchart illustrating an example of the flow of information processing performed by the keyword detection device 10E.

The response output module 27I outputs a response message including attributes (step S500).

Subsequently, the voice recognition module 20A acquires voice data as input information, and outputs text information as the recognition result of the voice data (step S502). The phrase detection module 20B detects a phrase related to a keyword from the text information output at step S502 (step S504).

The similarity calculation module 27C calculates output similarities conforming to similarities between one or a plurality of keywords in the keyword list 32, which correspond to the attributes included in the response message output at step S500, and the phrase detected at step S504 (step S506).

The keyword output module 21D outputs keywords in the keyword list 32 as first keywords according to the output similarities calculated at step S506 (step S508).

The keyword spotting module 21E extracts, as second keywords, keywords included in the keyword list 32 from the text information output at step S502 (step S510). The keyword spotting module 21E may extract, as the second keywords, keywords in the keyword list 32, which correspond to the attributes included in the response message, from the text information output at step S502.

The keyword selection module 21F selects at least one of the first keywords, which are the keywords output from the keyword output module 21D at step S508, and the second keywords extracted at step S510 (step S512). Then, the present routine is ended.

As explained above, the keyword detection device 10E of the present embodiment includes the response output module 271. The response output module 271 outputs a response message including the attributes registered in the keyword list 34. The similarity calculation module 27C calculates an output similarity conforming to a similarity between a phrase detected from text information, which is the recognition result of input information that is input after the response message is output from the response output module 271, and keyword form information in the keyword list 34 corresponding to the attributes included in the response message.

In this way, in the present embodiment, the similarity calculation module 27C calculates the output similarity conforming to the similarity between the phrase detected from the text information, which is the recognition result of the input information that is input after the response message is output from the response output module 271, and the reading, which is the keyword form information in the keyword list 34 corresponding to the attributes included in the response message. Therefore, the keyword detection device 10E of the present embodiment can suppress the output of keywords corresponding to attributes other than those included in the response message.

Consequently, the keyword detection device 10E of the present embodiment can output a correct keyword from input information, in addition to the effects of the above embodiments.

### Sixth Embodiment

A sixth embodiment will be explained next. In the description of the sixth embodiment, the same reference numerals are assigned to the same parts as in the above embodiments, a description thereof will be omitted, and parts different from those of the above embodiments will be explained.

In the present embodiment, as in the above embodiments, an example in which an input form is voice and input information is voice data will be explained.

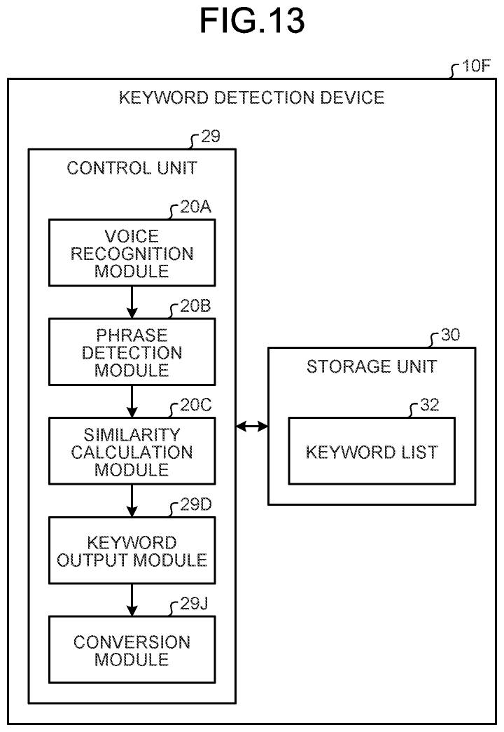

FIG. 13 is a functional block diagram of an example of a keyword detection device 10F of the present embodiment.

The keyword detection device 10F includes a control unit 29 and the storage unit 30. The control unit 29 and the storage unit 30 are connected to be able to exchange data and signals. The storage unit 30 is the same as in the above embodiments.

The control unit 29 performs information processing in the keyword detection device 10F. The control unit 29 includes the voice recognition module 20A, the phrase detection module 20B, the similarity calculation module 20C, a keyword output module 29D, and a conversion module 29J. That is, the control unit 29 is the same as the control unit 20 of the above embodiment, except that the control unit 29 includes the keyword output module 29D instead of the keyword output module 20D and further includes the conversion module 29J.

The keyword output module 29D is the same as the keyword output module 20D of the above embodiment, except that the keyword output module 29D outputs keywords to the conversion module 29J.

The conversion module 29J generates conversion text information by converting phrases included in the text information into the keywords output from the keyword output module 29D. Then, the conversion module 29J outputs the conversion text information to an output unit such as a display.

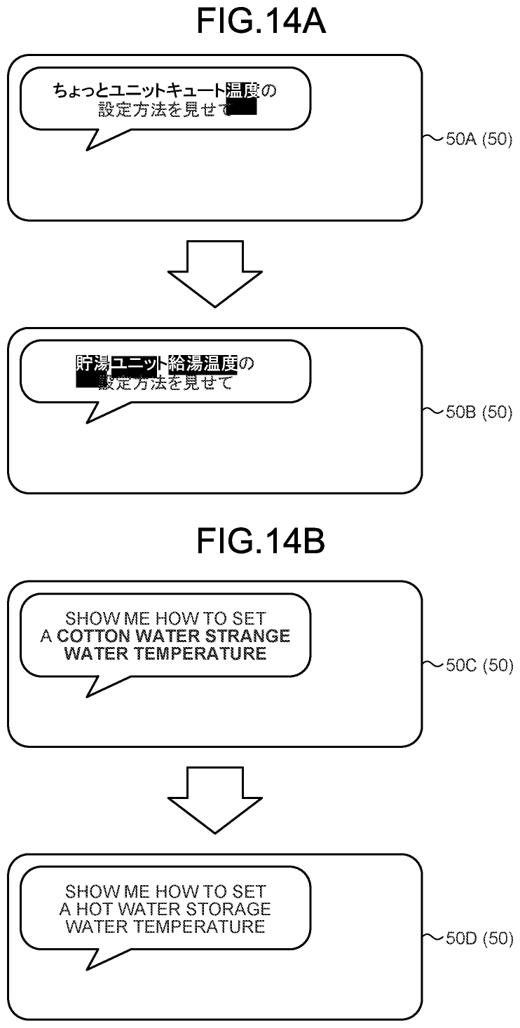

FIG. 14A is an explanatory diagram of an example of a display screen 50 output by the conversion module 29J. FIG. 14A illustrates an example of the display screen 50 when voice, which is input information, is Japanese voice.

For example, when the keyword output module 29D displays text information as the recognition result of voice data, a display screen 50A is displayed on the display. The display screen 50A includes text information including misrecognition, “ [symbol] [symbol] [symbol] ”. On the other hand, it is assumed that a phrase “ [symbol] [symbol] ” is detected by the phrase detection module 20B and a keyword “ [symbol] ” is output from the keyword output module 29D. In this case, the conversion module 29J outputs a display screen 50B including conversion text information obtained by converting the phrase “ [symbol] [symbol] ” included in the text information into the output keyword “ [symbol] ”.

FIG. 14B is an explanatory diagram of an example of the display screen 50 output by the conversion module 29J. FIG. 14B illustrates an example of the display screen 50 when voice, which is input information, is English voice.

For example, when text information is displayed as the recognition result of voice data, a display screen 50C is displayed on the display. The display screen 50C includes text information including misrecognition, “show me how to set a cotton water strange water temperature”. On the other hand, it is assumed that a phrase “cotton water strange water temperature” is detected by the phrase detection module 20B and a keyword “hot water storage water temperature” is output from the keyword output module 29D. In this case, the conversion module 29J outputs a display screen 50D including conversion text information obtained by converting the phrase “cotton water strange water temperature” included in the text information into the output keyword “hot water storage water temperature”.

Therefore, a user can easily confirm a correct recognition result by viewing the display screen 50.

An example of the flow of information processing performed by the keyword detection device 10F will be explained below.

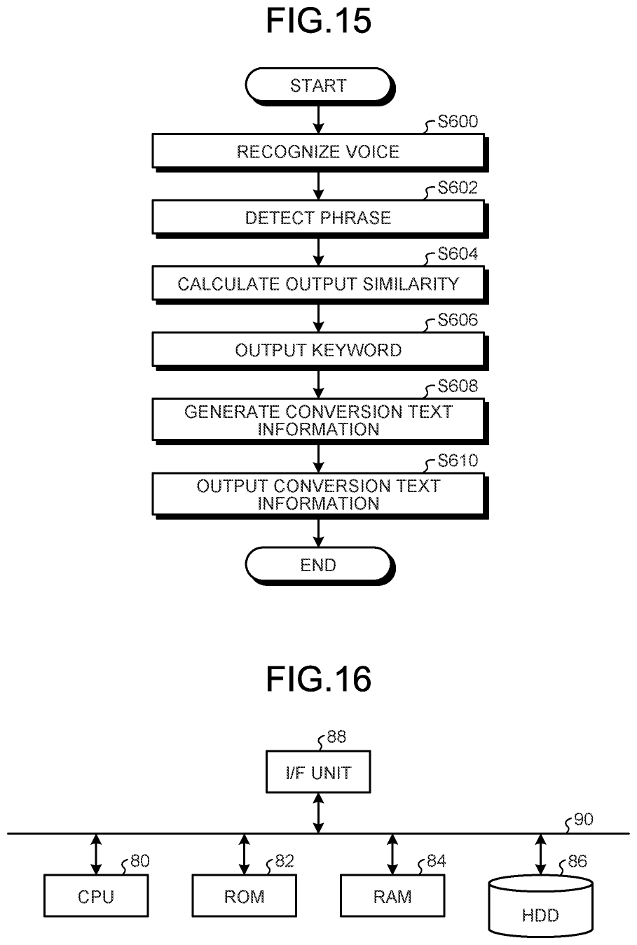

FIG. 15 is a flowchart illustrating an example of the flow of information processing performed by the keyword detection device 10F.

Processes of step S600, step S602, step S604, and step S606 are the same as the processes of step S100, step S102, step S104, and step S106 of the above first embodiment (see FIG. 3).

Specifically, the voice recognition module 20A acquires voice data as input information, and outputs text information as the recognition result of the voice data (step S600). The phrase detection module 20B detects a phrase related to a keyword from the text information output at step S600 (step S602). The similarity calculation module 20C calculates output similarities conforming to similarities between the keywords included in the keyword list 32 and the phrase detected at step S602 (step S604). The keyword output module 29D outputs keywords in the keyword list 32 according to the output similarities calculated at step S604 (step S606).

The conversion module 29J generates conversion text information by converting the phrases included in the text information output at step S600 into the keywords output from the keyword output module 29D at step S606 (step S608). Then, the conversion module 29J outputs the conversion text information to an output unit such as a display (step S610). Then, the present routine is ended.

As explained above, in the keyword detection device 10F of the present embodiment, the conversion module 29J generates conversion text information obtained by converting phrases included in text information into keywords output from the keyword output module 29D. Then, the conversion module 29J outputs the conversion text information to an output unit such as a display.

Therefore, the keyword detection device 10F of the present embodiment can provide a correct recognition result to be easily confirmed, in addition to the effects of the above embodiments.

### Modifications

In the above embodiments, the form in which an input form of input information is voice has been explained as an example. However, as described above, the input form of the input information may be key input that is input by an input device such as a keyboard, handwritten character input that is input via a handwriting board, or the like, and is not limited to voice.

In the above embodiments, the form has been explained in which the input form is voice, and the keyword list 32 and the keyword list 34 use characters representing a keyword as keyword notation, and use keyword reading as keyword form information. The similarity calculation module 20C and the similarity calculation module 27C have calculated a similarity between the reading of a phrase and the reading of a keyword.

When the input form of the input information is key input using a Romaji keyboard, such a form may be employed in which the keyword list 32 and the keyword list 34 use characters representing a keyword as keyword notation, and use Romaji representing a keyword as keyword form information. The similarity calculation module 20C and the similarity calculation module 27C may convert a phrase into an input key sequence, and may calculate a similarity between Roman characters of a keyword and Romaji sequence.

When the input form of the input information is handwritten character input, such a form may be employed in which the keyword list 32 and the keyword list 34 use characters representing a keyword as keyword notation, and use an arrangement of stroke information at the time of handwritten character input of a keyword as keyword form information. The stroke information uses information represented by the shape of a line in a stroke. Then, an arrangement in which each character constituting a keyword is broken down into the stroke information and written in sequence may be registered in advance in the keyword list 32 and the keyword list 34 as keyword form information.

Then, the similarity calculation module 20C and the similarity calculation module 27C may calculate a similarity between the arrangement in which each character constituting a phrase is broken down into the stroke information and written in sequence and an arrangement of stroke information of the keyword.

### Hardware Configuration

The hardware configuration of each of the keyword detection device 10 and the keyword detection device 10B to the keyword detection device 10F of the above embodiments will be explained.

FIG. 16 is a diagram illustrating an example of the hardware configuration of each of the keyword detection device 10 and the keyword detection device 10B to the keyword detection device 10F of the above embodiments.

The keyword detection device 10 and the keyword detection device 10B to the keyword detection device 10F of the above embodiments each have a hardware configuration using a normal computer, in which a CPU 80, a read only memory (ROM) 82, a random access memory (RAM) 84, an HDD 86, and an I/F unit 88, and the like are interconnected by a bus 90.

The CPU 80 is an arithmetic device that controls the information processing performed by the keyword detection device 10 and the keyword detection device 10B to the keyword detection device 10F of the above embodiments. The RAM 84 stores data required for various processes by the CPU 80. The ROM 82 stores a computer program and the like for implementing various processes by the CPU 80. The HDD 86 stores data. The I/F unit 88 is an interface for transmitting and receiving data to and from other devices.

The computer program for performing the above various processes performed by the keyword detection device 10 and the keyword detection device 10B to the keyword detection device 10F of the above embodiments is provided by being incorporated in advance in the ROM 82 or the like.

The computer program to be executed by the keyword detection device 10 and the keyword detection device 10B to the keyword detection device 10F of the above embodiments may be provided by being recorded on a computer readable recording medium, such as a CD-ROM, a floppy disk (FD), a CD-R, and a digital versatile disk (DVD), in a file format installable or executable in these devices.

The computer program to be executed by the keyword detection device 10 and the keyword detection device 10B to the keyword detection device 10F of the above embodiments may be configured to be provided by being stored on a computer connected to a network such as the Internet and downloaded via the network. The computer program for executing each of the above processes in the keyword detection device 10 and the keyword detection device 10B to the keyword detection device 10F of the above embodiments may be configured to be provided or distributed via the network such as the Internet.

The computer program for executing the above various processes performed by the keyword detection device 10 and the keyword detection device 10B to the keyword detection device 10F of the above embodiments is such that each of the above-described units is generated on a main storage device.

Various information stored in the above HDD 86 may be stored in an external device. In this case, the external device and the CPU 80 are configured to be connected via a network or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A keyword detection device comprising:
a memory; and
one or more processors coupled to the memory and configured to:
detect a phrase related to a keyword from text information that is a recognition result of input information represented in a predetermined input form;
calculate output similarities conforming to similarities between the phrase and keywords included in a keyword list in which, for each of the keywords, keyword notation of the corresponding keyword is associated with keyword form information representing the corresponding keyword in the input form; and
output the keywords in the keyword list according to the output similarities.

2. The keyword detection device according to claim 1, wherein the one or more processors are configured to output a predetermined number of the keywords in descending order of the output similarities or keywords with the output similarities equal to or greater than a threshold, which are included in the keyword list.

3. The keyword detection device according to claim 1, wherein
the one or more processors are further configured to output the text information as the recognition result of voice data that is the input information.

4. The keyword detection device according to claim 3, wherein the keyword form information includes information representing reading of the keyword.

5. The keyword detection device according to claim 1, wherein
the one or more processors are configured to:
detect, from the text information, the phrase and a probability that the phrase is the keyword; and
calculate the output similarities conforming to the probability of the phrase and the similarities between the phrase and the keywords included in the keyword list.

6. The keyword detection device according to claim 1, wherein
the one or more processors are configured to:
detect a plurality of the phrases related to the keywords from the text information, and
calculate, as the output similarities, similarities between the keywords included in the keyword list and each of the phrases.

7. The keyword detection device according to claim 5, wherein the one or more processors are configured to calculate, for each of the keywords included in the keyword list, the output similarity by using the similarity with the phrase, the probability of the phrase, and a weighted value for at least one of the similarity and the probability.

8. The keyword detection device according to claim 1, wherein
the one or more processors are configured to:
detect a plurality of the phrases having different numbers of characters related to the keywords from the text information, and
calculate the output similarities with a weighted value for reducing the similarities between the keywords included in the keyword list and each of the phrases as the number of characters in the keyword decreases.

9. The keyword detection device according to claim 8, wherein the one or more processors are configured to calculate the output similarities of each of phrases including the detected phrases and expanded/shrunken phrases obtained by performing at least one of expansion and shrinkage on the phrases by a predetermined number of characters in the text information.

10. The keyword detection device according to claim 1, wherein
the one or more processors are further configured to:
extract the keywords included in the keyword list from the text information as second keywords; and
select at least one of first keywords, which are the output keywords, and the second keywords.

11. The keyword detection device according to claim 10, further comprising
the one or more processors are further configured to:
specify a group of the keywords, in which at least some of corresponding regions in the text information overlap, for each of one or a plurality of the first keywords and one or a plurality of the second keywords, the first and second keywords being output according to the output similarities conforming to the similarities between the keywords included in the keyword list and the phrase detected from each of a plurality of pieces of the text information that is the recognition result of the input information; and
select, among the one or the plurality of first keywords and the one or the plurality of second keywords, at least one of the keywords belonging to the same group and at least one of the one or the plurality of the keywords not belonging to the group.

12. The keyword detection device according to claim 10, further comprising
the one or more processors are further configured to:
generate a retrieval query, among a plurality of the selected keywords, by combining the keywords in which corresponding regions in the text information overlap with an OR condition and combining the keywords in which the corresponding regions do not overlap with an AND condition; and
search a database by using the retrieval query.

13. The keyword detection device according to claim 1, wherein
the keyword list includes a list in which, for each of the keywords, the keyword notation, the keyword form information, and an attribute of the keyword are associated with one another, and
the one or more processors are configured to:
output a response message including the attribute; and
calculate the output similarity conforming to the similarity between the phrase detected from the text information that is the recognition result of the input information input after the response message is output, and the keyword form information corresponding to the attribute included in the response message in the keyword list.

14. The keyword detection device according to claim 1, wherein
the one or more processors are further configured to generate conversion text information obtained by converting the phrase included in the text information into the output keywords.

15. A keyword detection method comprising:
detecting a phrase related to a keyword from text information that is a recognition result of input information represented in a predetermined input form;
calculating output similarities conforming to similarities between the phrase and the keywords included in a keyword list in which, for each of the keywords, keyword notation of the corresponding keyword is associated with keyword form information representing the corresponding keyword in the input form; and
outputting the keywords in the keyword list according to the output similarities.

16. A computer program product comprising a computer-readable medium including programmed instructions, the instructions causing a computer to execute:
detecting a phrase related to a keyword from text information that is a recognition result of input information represented in a predetermined input form;
calculating output similarities conforming to similarities between the phrase and the keywords included in a keyword list in which, for each of the keywords, keyword notation of the corresponding keyword is associated with keyword form information representing the corresponding keyword in the input form; and
outputting the keywords in the keyword list according to the output similarities.
